(19) United States
(12) Patent Application Publication
(10) Pub. No.: US 2024/0164241 A1
(43) Pub. Date: May 23, 2024

(54) METHOD AND SYSTEM FOR GENERATING A CROP AGRONOMY PREDICTION

(71) Applicant: BASF AGRO TRADEMARKS GMBH, Ludwigshafen (DE)

(72) Inventors: Zhisheng QIN, Durham, NC (US); Xiangming ZENG, State College, PA (US); Abhishes LAMSAL, Durham, NC (US); Jeffrey Thomas SPENCER, Bellefonte, PA (US); Bjoern KIEPE, Köln (DE)

(21) Appl. No.: 18/284,093

(22) PCT Filed: Mar. 25, 2022
(86) PCT No.: PCT/EP2022/057868

§ 371 Date: Sep. 26, 2023

(30) Foreign Application Priority Data
Mar. 26, 2021 (EP) 21165367.0

(51) Int. Cl. A01B 79/00; A01B 79/02; G06N 20/20

(52) U.S. Cl. CPC A01B 79/005; A01B 79/02; G06N 20/20

(57) ABSTRACT

A method for generating a crop phenology prediction (7) is provided. The method comprises the steps of providing crop phenology training data (1) for a plurality of crops and a plurality of locations (17); training a machine learning system (6) using the crop phenology training data (1); providing a selection of the plurality of crops and a specific location (18); and generating a crop phenology prediction (7) for a selection of the plurality of crops at a specific location (18) using the trained machine learning system (6). Further, a system (21) for generating a crop phenology prediction (7) is provided. The system (21) comprises at least one input interface (25) for providing a selection of crops and a specific location (18), at least one processing unit (22) configured to carry out the method for generating a crop phenology prediction (7) and at least one output interface (23) for outputting the crop phenology prediction (7), the agronomic recommendation (8) and/or the agronomic control data (26) for the selection of crops at the specific location (18). Further, a computer program element, a use of a crop phenology prediction (7) and a use of agronomic control data (26) are provided.

### FIELD OF THE INVENTION

The present invention relates to digital farming. In particular, the present invention relates to a method for generating a crop phenology prediction, to a system for generating a crop phenology prediction and to a computer program element. The present invention further relates to a use of a crop phenology prediction and/or an agronomic recommendation.

### BACKGROUND OF THE INVENTION

An accurate prediction of a crop phenology, in particular a growth stage of a crop, may be used in a wide variety of ways. In particular, the crop phenology prediction may be used to determine an optimal time for harvesting the crop, a time and an amount of fertilizer to be applied to a field or as an input for a pest or disease model, such that an optimal time and amount for the application of agricultural substances, e.g., herbicides or pesticides, may be found.

Known ways to predict a crop phenology which is, in particular, used to infer an agronomic recommendation or control data to control an agricultural device, are based on agronomic and/or physiological principles. In order to achieve accurate predictions, these models have to be calibrated, in particular with observational data. If a crop phenology prediction is required for a different kind of crop and/or a different location, a new calibration has to be performed in order to achieve an accurate prediction. Depending on the details of the model structure, such a calibration may be moderately to very difficult.

### SUMMARY OF THE INVENTION

It is therefore an object of the present invention to provide an easy and fast method for generating a crop phenology prediction and a corresponding system for generating a crop phenology prediction.

The object of the present invention is solved by the subject-matter of the independent claims, wherein further embodiments are incorporated in the dependent claims.

According to a first aspect of the invention, a method for generating a crop phenology prediction is provided.

In this context, “crop” is to be interpreted widely and refers to any crop plants that are produced, grown or sown on an agricultural field, a horticultural field or a silvicultural field. Preferred crops are Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and Prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera and Zea mays. Most preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (S. vulgare), Triticale, Triticum aestivum, Triticum durum, Vicia faba, Vitis vinifera and Zea mays. Especially preferred crops are crops of cereals, corn, soybeans, rice, oilseed rape, cotton, potatoes, peanuts or permanent crops.

Phenology refers, in particular, to events in biological life cycles, more particularly to growth stages of the crop. Said growth stages may include germination, sprouting, bud development, leaf development, formation of side shoots, tillering, stem elongation or rosette growth, shoot development, development of harvestable vegetative plant parts, bolting, inflorescene emergence, heading, flowering, development of fruit, ripening or maturity of fruit and seed, senescence and beginning of dormancy.

According to the method, crop phenology training data is provided for a plurality of crops and a plurality of locations. In this context, plurality refers to at least two and, in particular, there may be tens or hundreds of locations for which training data is provided. The different crops may be referred to by a name of the crop or by a crop ID associated with the crop.

The crop phenology training data is used to train a machine learning system. Many different machine learning systems may be used and the specific details of the training are dependent on the machine learning system used. By using training data for the plurality of crops and the plurality of locations, the machine learning system may recognize links between the different crops and the different locations. As an example, training data may be provided for winter wheat for one location, for winter barley for the same location and for winter wheat for another location. By recognizing links between the different locations and between the different crops, the machine learning system may then be able to produce a meaningful crop phenology prediction for winter barley at the other location, which was not part of the training data. Hence, learned features may be transferred between crops and between locations.

Once the machine learning system has been trained, a selection of the plurality of crops and a specific location is provided, e.g., by user input or as a request of an agricultural device, and a crop phenology prediction is generated for the selection of the plurality of crops at the specific location. The generation of the crop phenology prediction makes use of the trained machine learning system.

The method as described above has several advantages. First, once the general machine learning system has been set up, it is easy to expand it to different or additional crops, saving both manpower and computing time. Also, the machine learning system may be easily expanded to different or additional locations, again saving manpower and computing time. Furthermore, by construction, machine learning systems may find relations between different crops, different locations and/or different parameters that are difficult to foresee, predict and/or implement in a conventional model. Hence, the method as described above is both easy to implement and has a good predictive power.

According to an embodiment, the crop phenology training data comprises historical crop phenology data. That is, crop phenology data measured in the past is used as training data for the machine learning system. Said measurements of the crop phenology data may be made in a variety of ways, e.g., by manual examination by a farmer, by evaluations of camera images taken by an agricultural device or by evaluations of aerial images, taken, e.g., by satellites, drones, planes or helicopters. In particular, the historical crop phenology data is crop phenology data of past seasons. The more seasons that are covered by the historical crop phenology data the better the training of the machine learning system and the better the prediction of the crop phenology. Additionally or alternatively, the historical crop phenology data comprises crop phenology data of the current season. This has a further beneficial impact on the accuracy of the crop phenology prediction, since the effects on the crop during the current season, e.g., by weather, pests and/or diseases, are already included in the crop phenology data of the current season.

According to an embodiment, the crop phenology training data comprises process model generated crop phenology data. In this context, a process model is a conventional model to model crop phenology. The process model may, in particular, predict crop phenology crop by crop and country by country or location by location. The process model may be driven by thermal time, i.e., by accumulated heat units which may be calculated by aggregating temperatures suitable for growth and development for a specific crop, and by the photoperiod, i.e., the length of the day. The process model may be calibrated per crop and per maturity group, wherein maturity group refers to the biological characteristics defining the amount of heat units needed for the crop to reach maturation. The process model may be further calibrated with respect to the photo sensitivity, i.e., the sensitivity of the crop development to the length of the day. If the process model has been thoroughly calibrated, the process model generated crop phenology data is valuable training data for the machine learning system.

In particular, a combination of historical crop phenology data and process model generated crop phenology data may be used as crop phenology training data. Said combination is particularly useful when historical crop phenology data exists for a certain set of crops and/or locations and process model generated crop phenology data exists for a different set of crops and/or locations and the combination of historical crop phenology data and process model generated crop phenology data leads to a significant increase in available crop phenology training data.

According to an embodiment, the crop phenology training data comprises crop identifiers and crop phenology indicators. The crop identifiers may be crop names and/or crop IDs, providing a unique identification of the crop. Additionally or alternatively, the crop identifiers are maturation characteristics, e.g., a required amount of heat units needed for the crop to reach maturation. Said maturation characteristics may be used by the machine learning system to link different crops to one another. In this context, the crop phenology indicators may also be referred to as crop phenology descriptors. The crop phenology indicators may be provided, e.g., on the BBCH scale. The BBCH scale provides numerical codes for growth stages of the crop such as germination, sprouting, bud development; leaf development; formation of side shoots, tillering; stem elongation or rosette growth, shoot development; development of harvestable vegetative plant parts, bolting; inflorescene emergence, heading; flowering; development of fruit; ripening or maturity of fruit and seed; and senescence, beginning of dormancy. Said crop phenology indicators are suitable to describe the crop phenology in a comprehensible way. In particular, the crop phenology training data comprises the crop phenology indicators as a function of time, e.g., for every day of a growing season, for every day of the year, for every other day and/or for every week of the growing season or the year.

According to an embodiment, the crop phenology training data further comprises at least one out of a group, the group consisting of geolocation identifiers, agricultural method identifiers, planting dates, days after planting, relationship of crop growth stage and accumulated growing degree days identifiers, biophysical descriptors, weather descriptors, and plant growth regulators application descriptors. The geolocation identifiers may comprise the latitude and/or longitude of the location of the agricultural field where the crop is planted. With both the latitude and longitude, the exact location and/or specific location is determined. The geolocation identifiers may further comprise the altitude of the location of the agricultural field and/or the region, country and/or continent where the agricultural field is located. In particular, the latitude and the altitude may provide a first approximation of the weather and/or climate at the given location. Agricultural method identifiers may include, e.g., greenhouses or foils underneath which the crop is grown. Since these agricultural methods have an impact, e.g., on the temperature of the air and/or soil surrounding the crop, there is an impact on the development of crop phenology. Taking this impact into account in the machine learning system improves the crop phenology prediction. The crop phenology is also dependent on the planting dates and/or days after planting of the crop such that taking this information into account in the machine learning system also improves the crop phenology prediction. The relationship of crop growth stage and accumulated growing degree days identifiers are derived quantities identifying the relationship of the crop growth stage, measured, e.g., on the BBCH scale, and accumulated growing degree days, i.e., accumulated thermal units. Said relationship may be established, e.g., by determining a linear regression equation for the crop growth stage and the accumulated growing degree days. For said determination of the linear regression equation, only a certain range of crop growth stage values and/or accumulated growing degree days values may be used, e.g., only the data where the BBCH scale is between 20 and 80 and/or only the data where the accumulated growing degree days are between 200 and 1500. From the determined linear regression equation, the slope and/or the intercept may be used as the relationship of crop growth stage and accumulated growing degree days identifier. Both the slope and the intercept of the determined linear regression equation are simple numbers that effectively account for variations of the model behavior at different locations, in particular in different countries or on different continents and/or provide links between different crops and/or different locations. Biophysical descriptors are, e.g., a biomass index and/or a leaf area index and supplement the crop phenology indicators. In particular, said biophysical descriptors may be acquired from satellite images and may therefore be frequently acquired. Since the weather also influences the development of crop phenology, weather descriptors also provide valuable information to the machine learning system. Here, weather descriptors refer both to the climate and the weather in the past and to weather predictions, e.g., weather forecasts. The weather descriptors may include growing degree days, i.e., the number of days at which the temperature was suitable for the growth of the crop, soil temperature, air temperature, solar radiation, day length and/or precipitation. Also, the application of plant growth regulators influences the development of crop phenology. In this context, plant growth regulators may be fertilizers and/or water. The plant growth regulators application descriptors may include the dates, amounts of and types of the applied plant growth regulators.

According to an embodiment, the crop phenology prediction comprises a growth stage prediction, in particular on the BBCH scale. The growth stage prediction may be a prediction of the growth stage of the crop for a few days or even until ripening or senescence of the crop. The BBCH scale, which may be used to indicate the crop phenology, has been described above.

According to an embodiment, at least two locations out of the plurality of locations and/or specific location are on different continents, in particular in different countries. Hence, the method may be applied across borders of countries and/or continents and has, therefore, a great range of applicability.

According to an embodiment, the specific location is different from any of the plurality of locations. That is, the crop phenology training data does not include crop phenology data for the specific location. In this case, the machine learning system makes use, inter alia, of the geolocation identifiers and/or the weather descriptors to predict the crop phenology at the specific location. Hence, the method is even applicable to locations for which no historical crop phenology data or process model generated crop phenology data exists. Alternatively, the selection of the plurality of crops is different from the crops at the specific location provided in the crop phenology training data. In other words, the crop phenology prediction is requested for one or more crops at a specific location, while the crop phenology training data does not contain any data for said crops at the specific location. However, the crop phenology training data contains data for other crops at the specific location and it contains data for the selection of the plurality of crops at different locations. This is where links between different locations and different crops that have been established during the training of the machine learning system play an important role: using these links, the trained machine learning system is able to generate a useful crop phenology prediction even in this case.

According to an embodiment, the machine learning system is a decision tree, in particular a gradient boosted decision tree. Said gradient boosted decision tree is fast and has a good performance. Alternatively, the machine learning system is a computer-implemented neural network or an artificial neural network. Also, a combination of machine learning systems may be used. For training the machine learning system, the crop phenology training data is split into two parts, one for training and one for testing, e.g., 90% of the data for training and 10% for testing. Advantageously, said split is such that both parts cover a large part of the plurality of crops and the plurality of locations. When training and testing the machine learning system, a mean absolute error may be used as evaluation metric. In particular, the mean absolute error may refer to the error on the BBCH scale for a given day or to the error in time for a given BBCH code.

According to an embodiment, the method further comprises adding new data to the crop phenology training data, updating the machine learning system by training with the new data and generating an updated crop phenology prediction for the selection of the plurality of crops at the specific location using the updated machine learning system. In this way, the machine learning system is updated without having to train it with the whole crop phenology training data again. Said updating is particularly useful to include a new kind of crop and/or a new location. Also, said updating may be performed to include recent crop phenology data, which is particularly important for an accurate prediction of the crop phenology.

According to an embodiment, the method further comprises generating an agronomic recommendation and/or agronomic control data. The agronomic recommendation and/or the agronomic control data may comprise a time, an amount of and/or a type of an agricultural substance and/or agricultural product to be applied to a field at the specific location with the selection of the plurality of crops. The agronomic control data is configured to control an agricultural device, e.g., an agricultural vehicle or an agricultural robot, in particular a smart spraying system, to apply the specified amount and/or type of the agricultural substance and/or agricultural product at the specified time to the field at the specific location. In this context, an agricultural substance or an agricultural product is in particular a crop protection product such as fungicides, herbicides, insecticides, acaricides, molluscicides, nematicides, avicides, piscicides, rodenticides, repellants, bactericides, biocides, safeners, plant growth regulators, urease inhibitors, nitrification inhibitors, denitrification inhibitors, or any combination thereof. The agronomic recommendation and/or the agronomic control data may also comprise a time for planting and/or harvesting a field at the specific location with the selection of the plurality of crops. Said agronomic recommendation and/or agronomic control data is generated based on the crop phenology prediction. The agronomic control data for planting a field may be used, e.g., to control a smart seeding system. As an example, the recommendation and/or the control data for harvesting a field may be made based on the predicted time for a certain degree of ripening of the crop on the field. Also, the recommendation and/or control data for applying certain agricultural substances or agricultural products may be made based on the predicted time for a certain growth stage of the crop on the field. A more elaborate way of generating recommendations and/or control data is to generate several crop phenology predictions for the selection of the plurality of crops at the specific location with varying times and amounts of agricultural substances or agricultural products to be applied. The agronomic recommendation and/or agronomic control data is then based, inter alia, on the predicted crop phenology, e.g., the sooner the crop is ripe, the better. In this example, the agronomic recommendation and/or the agronomic control data may also be based on the amounts of agricultural substances or agricultural products used, wherein smaller amounts are better. Hence, the agronomic recommendation and/or the agronomic control data may be a trade-off between predicted crop phenology and need for agricultural substances or agricultural products to achieve said prediction.

According to another aspect of the invention, a system for generating a crop phenology prediction is provided. The system comprises at least one input interface for providing a selection of crops and a specific location as well as at least one processing unit configured to carry out a method for generating a crop phenology prediction according to the above description. The input interface may be a human-machine-interface or a network interface, adapted to receive a request for a crop phenology prediction, an agronomic recommendation and/or agronomic control data. In the latter cases, the request may be sent, e.g., via e-mail, text message, push message from an application or a web form. In particular, the request may be sent by a user, particularly a farmer, or by an agricultural device. The system further comprises at least one output interface for outputting the crop phenology prediction, the agronomic recommendation and/or the agronomic control data for the selection of crops at the specific location. Said output interface may be, in particular, a network interface, adapted to connect the processing unit to the internet such that the crop phenology prediction, the agronomic recommendation and/or the agronomic control data may be sent to a user, particularly to a farmer, and/or to an agricultural device such as an agricultural vehicle or an agricultural robot, in particular a smart spraying system, a smart seeding system and/or a smart harvesting system. Sending the crop phenology prediction, the agronomic recommendation and/or the agronomic control data may be performed, e.g., by e-mail, text message, push message to an application or direct file or data transfer.

According to another aspect of the invention, a computer program element is provided. When executed by a processor in a system according to the above description, the computer program element is configured to carry out a method according to the above description. The advantages of the method, as described above, also apply to the computer program element.

According to another aspect of the invention, a use of a crop phenology prediction and/or an agronomic recommendation generated according to a method according to the above description for determining a time and/or details of an agricultural treatment is provided. The agricultural treatment may be, in particular, planting and/or harvesting a field and/or applying agricultural substances and/or agricultural products to a field. The agronomic recommendation may be directly used whereas the crop phenology prediction may be used by a user, in particular a farmer, combined with the knowledge of the user. As an example, the user may use the crop phenology prediction to find out when the crop has reached a certain growth stage and is ready for harvesting. As another example, the user may use the crop phenology prediction to find out when the crop will reach a certain growth stage such that the application of an agricultural substance and/or an agricultural product is allowed and/or recommended.

According to yet another aspect of the invention, a use of agronomic control data generated according to a method according to the above description for controlling an agricultural device to plant and/or harvest a field and/or to apply agricultural substances and/or agricultural products to a field is provided. The agricultural device may be an agricultural vehicle or an agricultural robot. In particular, the agricultural device may be a smart seeding system, a smart harvesting system and/or a smart spraying system. An agricultural device controlled in this way will work more economically, obtain a better quality crop and/or use a smaller amount of agricultural substances and/or agricultural products.

According to yet another aspect of the invention, the crop phenology prediction may be used, in particular in combination with other parameters such as humidity or wind speed, as an input for a pest and/or disease model. The pest and/or disease model predicts the emergence of pests and/or diseases. Since pests and/or disease are often linked to a certain growth stage of the crop, the crop phenology prediction is an important input to these models. Based on the output of the pest and/or disease model, further agronomic recommendations may be made, e.g., for the time and/or details of an agricultural treatment.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 shows a conceptual flowchart of a method for generating a crop phenology prediction;

FIG. 2 shows a data structure of crop phenology training data;

FIG. 3 shows a map with locations;

FIG. 4 shows a crop phenology prediction;

FIG. 5 shows a schematic embodiment of a system for generating a crop phenology prediction; and

FIG. 6 shows a schematic embodiment of a system for generating agronomic control data.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF EMBODIMENTS

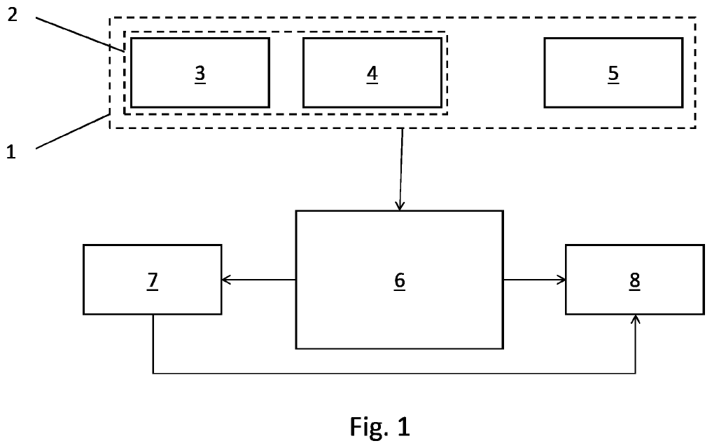

FIG. 1 shows a conceptual flowchart of a method for generating a crop phenology prediction. First, crop phenology training data 1 for a plurality of crops and a plurality of locations is provided. Said crop phenology training data 1 comprises historical crop phenology data 2. The historical crop phenology data 2 comprises both crop phenology data of past seasons 3 and crop phenology data of the current season 4. The more seasons that are covered by the historical crop phenology data 2 the better the training of the machine learning system and the better the prediction of the crop phenology. The crop phenology training data 1 also comprises process model generated crop phenology data 5. The process model may be, e.g., driven by thermal time, i.e., by accumulated heat units which may be calculated by aggregating temperatures suitable for growth and development for a specific crop, and by the photoperiod, i.e., the length of the day. It may be calibrated per crop and per maturity group, wherein maturity group refers to the biological characteristics defining the amount of heat units needed for the crop to reach maturation. The process model may be further calibrated with respect to the photo sensitivity, i.e., the sensitivity of the crop development to the length of the day. A thoroughly calibrated process model yields valuable process model generated crop phenology data 5.

The crop phenology training data 1 is used to train a machine learning system 6. Said machine learning system 6 may be a decision tree, in particular a gradient boosted decision tree, a computer-implemented neural network and/or an artificial neural network. For the training, one part, e.g., 90%, of the crop phenology training data 1 is used for training the machine learning system and the other part, e.g., 10%, of the crop phenology training data 1 is used for testing. When training and testing the machine learning system 6, a mean absolute error may be used as evaluation metric. In particular, the mean absolute error may refer to the error on the BBCH scale for a given day or to the error in time for a given BBCH code.

With the trained machine learning system 6, a crop phenology prediction 7 is generated for a selection of the plurality of crops, in particular for one specific crop, at a specific location, wherein the specific location does not necessarily have to be one of the plurality of locations in the crop phenology training data 1. The crop phenology prediction 7 is, in particular, a prediction of the growth stage of the crop, e.g., on the BBCH scale, i.e., it comprises the BBCH code for the crop for a set of dates in the future.

Further, an agronomic recommendation 8 and/or agronomic control data may be generated, either directly from the machine learning system 6 and/or via the crop phenology prediction 7. As an example, an agronomic recommendation 8 for harvesting a field may be made based on the predicted time for a certain degree of ripening of the crop on the field. Also, the agronomic recommendation 8 for applying certain agricultural substances or agricultural products may be made based on the predicted time for a certain growth stage of the crop on the field. A more elaborate way of generating agronomic recommendations 8 is to generate several crop phenology predictions 7 for the selection of the plurality of crops at the specific location with varying times and amounts of agricultural substances or agricultural products to be applied to the field. The agronomic recommendation 8 is then based, inter alia, on the crop phenology prediction 7, e.g., the sooner the crop is ripe, the better. In this example, the agronomic recommendation 8 may also be based on the amounts of agricultural substances or agricultural products used, wherein smaller amounts are better. Hence, the agronomic recommendation 8 may be a trade-off between predicted crop phenology and need for agricultural substances or agricultural products to achieve said prediction. The same applies to the agronomic control data, which is essentially the agronomic recommendation put in a control data format, i.e., formatted such that it may control and agricultural device, in particular an agricultural vehicle or an agricultural robot, more particularly a smart seeding system, a smart spraying system and/or a smart harvesting system.

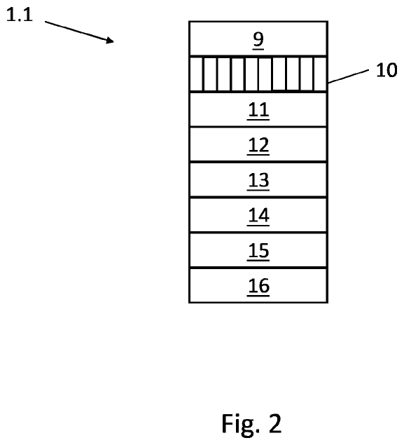

FIG. 2 shows an exemplary piece of crop phenology training data 1.1 for one crop and one location. This piece of crop phenology training data 1.1 may be either historical crop phenology data 2 or process model generated crop phenology data 5. The full crop phenology training data 1 comprises many such pieces of crop phenology training data 1.1, each for a different crop and/or a different location.

The piece of crop phenology training data 1.1 comprises a crop identifier 9, which may be a crop name or a crop ID. It further comprises a crop phenology indicators 10, e.g., on the BBCH scale. Said crop phenology indicator 10 comprises the growth stage of the crop for a plurality of dates. The piece of crop phenology training data 1.1 also comprises a geolocation identifier 11 which may include the latitude, longitude and altitude of the location as well as the region, country and/or continent of the location. It also comprises the planting dates 12 and/or the days after planting and weather descriptors 13, such as growing degree days, soil temperature, air temperature, solar radiation, day length and/or precipitation. The piece of crop phenology training data 1.1 may further comprise agricultural method identifiers 14, biophysical descriptors 15, plant growth regulators application descriptors 16 or relationship of crop growth stage and accumulated growing degree days identifiers.

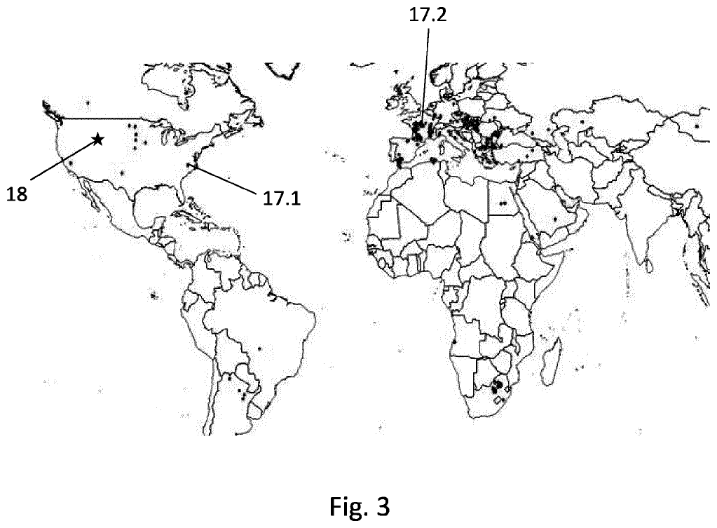

FIG. 3 shows a plurality of locations 17 that are included in the crop phenology training data 1, wherein only two out of the plurality of locations 17, 17.1 and 17.2, are labeled for clarity. For each of the plurality of locations 17, historical crop phenology data 2 and/or process model generated crop phenology data 5 is provided and included in the crop phenology training data 1.

As an example, also a specific location 18 for which the crop phenology prediction 7 is generated is shown in FIG. 3. Said specific location 18 may or may not be one of the plurality of locations 17. Naturally, the crop phenology prediction 7 may be easily generated for several specific locations 18, once the machine learning system 6 is trained.

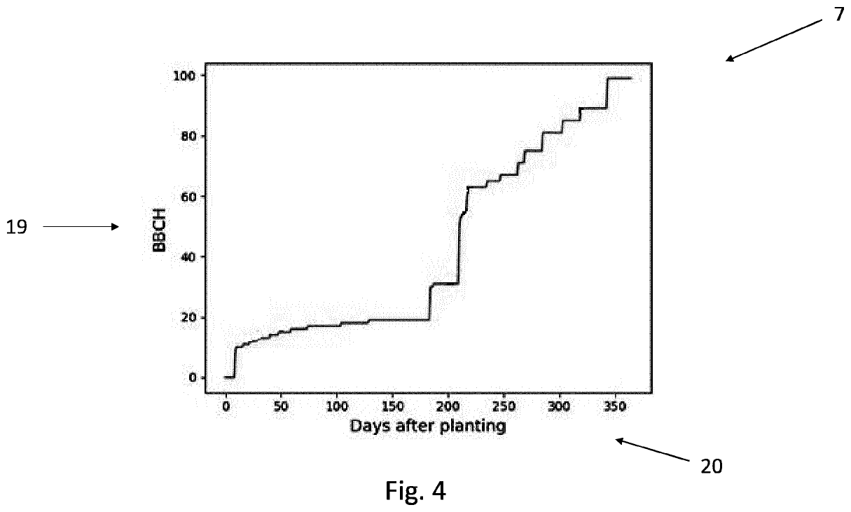

FIG. 4 shows a sample crop phenology prediction 7. This crop phenology prediction 7 is presented as a graph, but it may as well be presented as a table. The crop phenology prediction 7 shows the growth stage 19, on the BBCH scale, as a function of days after planting 20. Using said crop phenology prediction 7, a user, in particular a farmer, may find an optimal time for harvesting a crop, e.g., when the growth stage 19 reaches a code of 85 to 89 on the BBCH scale. Also, the user may consult the crop phenology prediction 7 to find an optimal time for an agricultural treatment, such as the application of agricultural substances and/or agricultural products to a field.

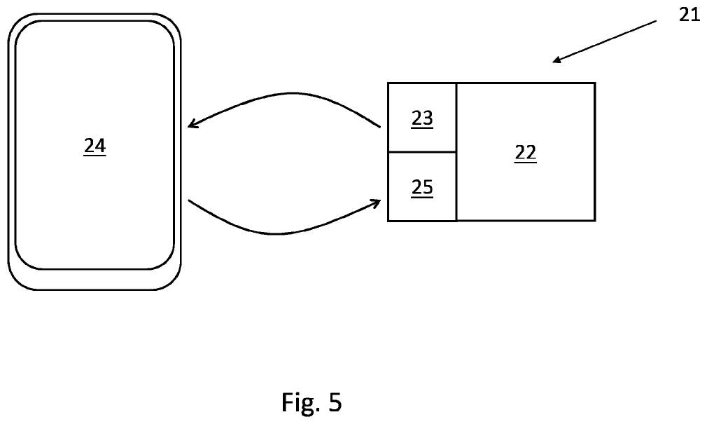

FIG. 5 shows a system 21 for generating a crop phenology prediction 7. The system 21 comprises a processing unit 22, configured to carry out the method for generating a crop phenology prediction 7 according to the above description. In particular, the system 21 is adapted to run a machine learning system 6, such as a decision tree, a computer-implemented neural network or an artificial neural network. The crop phenology training data 1 may be already present in the system 21, e.g., saved on a persistent storage medium, or may be obtained from an external database, which is not shown here.

The system 21 further comprises an output interface 23, adapted to output the crop phenology prediction 7 or the agronomic recommendation 8. Said output interface 23 may be, e.g., a network interface and the crop phenology prediction 7 or the agronomic recommendation 8 may be sent via e-mail, text message or push message, e.g., to a mobile device 24 of the user.

The system 21 also comprises an input interface 25, adapted to provide the selection of crops and the specific location 18 for which the crop phenology prediction 7 is to be generated. As depicted in FIG. 5, the input interface 25 is a network interface and the selection of crops and the specific location 18 are sent from the mobile device 24 of the user to the input interface 25 via e-mail, text message or push message. Alternatively or additionally, the input interface 25 may be a human-machine-interface.

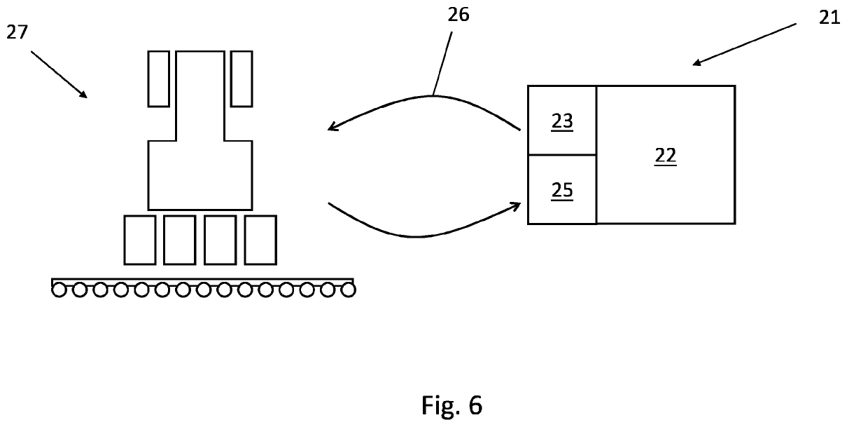

FIG. 6 shows a system 21 for generating agronomic control data 26 and is similar to the system 21 for generating a crop phenology prediction 7. In particular, the system 21 comprises a processing unit 22, an input interface 25 and an output interface 23.

The input interface 25 receives a request for agronomic control data from an agricultural device 27, which is depicted as a smart spraying system. Other agricultural devices 27 may be agricultural vehicles or agricultural robots, in particular smart seeding systems or smart harvesting systems.

Upon said request, the processing unit 22 generates the agronomic control data 26 and sends the agronomic control data 26 to the agricultural device 27. The agricultural device 27 is then controlled by the agronomic control data 26 and can therefore achieve an optimized performance, optimized crop quality and/or minimized application of agricultural substances and/or agricultural products.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A method for generating a crop phenology prediction (7) comprising:
providing crop phenology training data (1) for a plurality of crops and a plurality of locations (17);
training a machine learning system (6) using the crop phenology training data (1);
providing a selection of the plurality of crops and a specific location (18); and
generating a crop phenology prediction (7) for the selection of the plurality of crops at the specific location (18) using the trained machine learning system (6).

2. The method according to claim 1, wherein the crop phenology training data (1) comprises historical crop phenology data (2), in particular crop phenology data of past seasons (3) and/or crop phenology data of the current season (4).

3. The method according to claim 1, wherein the crop phenology training data (1) comprises process model generated crop phenology data (5).

4. The method according to claim 1, wherein the crop phenology training data (1) comprises crop identifiers (9) and crop phenology indicators (10).

5. The method according to claim 4, wherein the crop phenology training data (1) further comprises at least one out of a group, the group consisting of geolocation identifiers (11), agricultural method identifiers (14), planting dates (12), days after planting (20), relationship of crop growth stage and accumulated growing degree days identifiers, biophysical descriptors (15), weather descriptors (13), and plant growth regulators application descriptors (16).

6. The method according to claim 1, wherein the crop phenology prediction (7) comprises a growth stage (19) prediction, in particular on the BBCH scale.

7. The method according to claim 1, wherein at least two locations (17.1, 18; 17.2) out of the plurality of locations (17) and the specific location (18) are on different continents, in particular in different countries.

8. The method according to claim 1, wherein the specific location (18) is different from any of the plurality of locations (17) or the selection of the plurality of crops is different from the crops at the specific location (18) provided in the crop phenology training data (1).

9. The method according to claim 1, wherein the machine learning system (6) is a decision tree, in particular a gradient boosted decision tree, a computer-implemented neural network and/or an artificial neural network.

10. The method according to claim 1, wherein the method further comprises:
adding new data to the crop phenology training data (1);
updating the machine learning system (6) by training with the new data; and
generating an updated crop phenology prediction (7) for the selection of the plurality of crops at the specific location (18) using the updated machine learning system (6).

11. The method according to claim 1, wherein the method further comprises:
generating an agronomic recommendation (8) and/or agronomic control data (26) based on the crop phenology prediction, wherein the agronomic recommendation (8) and/or the agronomic control data (26) comprise in particular a time, an amount of and/or a type of an agricultural substance and/or agricultural product to be applied to a field at the specific location (18) with the selection of the plurality of crops and/or a time for planting and/or harvesting a field at the specific location (18) with the selection of the plurality of crops.

12. A system for generating a crop phenology prediction (7), the system comprising:
at least one input interface (25) for providing a selection of crops and a specific location (18);
at least one processing unit (22) configured to carry out a method for generating a crop phenology prediction (7) according to the method of claim 1; and
at least one output interface (23) for outputting the crop phenology prediction (7), the agronomic recommendation (8) and/or the agronomic control data (26) for the selection of crops at the specific location (18).

13. A non-transitory computer-readable medium having instructions encoded thereon that, when executed by a processor in a system (21), cause the processor to carry out a method according to claim 1.

14. Use of a crop phenology prediction (7) and/or an agronomic recommendation (8) generated according to a method according to claim 1 for determining a time and/or details of an agricultural treatment, in particular planting and/or harvesting a field and/or applying agricultural substances and/or agricultural products to a field.

15. Use of agronomic control data (26) generated according to a method according to claim 11 for controlling an agricultural device (27) to plant and/or harvest a field and/or to apply agricultural substances and/or agricultural products to a field.
